(19) United States
(12) Patent Application Publication
(10) Pub. No.: US 2015/0019303 A1
(43) Pub. Date: Jan. 15, 2015

(54) DATA QUALITY INTEGRATION

(71) Applicant: BANK OF AMERICA CORPORATION, Charlotte, NC (US)

(72) Inventor: Deepak K. Rao, Concord, NC (US)

(21) Appl. No.: 13/939,952

(22) Filed: Jul. 11, 2013

(51) Int. Cl. G06Q 10/06

(52) U.S. Cl. CPC G06Q 10/06395
USPC 705/7.41

(57) ABSTRACT

Embodiments of the present invention relate to systems, methods, and computer program products for determining reusable templates and parameters for evaluating quality of data. In one embodiment, a system comprises a processor configured to: (a) provide a plurality of element types; (b) provide a template for each of the plurality of element types; (c) use input from the template for each of the plurality of elements types to generate one or more parameter files for one or more data elements; (d) provide the one or more parameter files to one or more workflow processes for generating queries that are used for measuring and evaluating the one or more data elements; and (e) parameterize the generated queries, such that the generated queries can be reused in measuring and/or evaluating data elements.

### FIELD

In general, embodiments of the present invention relate to apparatuses, systems, methods, and computer program products generating a template useable for initializing data quality measuring and the parameterization of key process elements for defining a re-usable system for measuring the quality of data of key data elements.

### BACKGROUND

Many financial institutions, such as banks, are required by legislation and/or regulations to ensure that the data that it stores relating to its customers are accurate. As such, many of the regulations require that the financial institutions implement procedures for testing the quality of the data that the financial institution stores to ensure that it is in compliance with the regulations. To meet the regulatory requirements and risk measures, financial institutions perform data quality checks on different key data elements stored in a database. In some cases, there may be thousands of key data elements that must be checked by the financial institution. The process of performing the data quality checks can be time and labor intensive. Currently, to check each data element, a bank may implement a system with a 1-to-1 rules ratio that prepares a rule for every one data element in the database, which can equate to thousands of rules. The 1-to-1 rule ratio is less than desirable. Accordingly, it would be desirable to provide systems and methods for streamlining data quality checks.

### SUMMARY OF SELECTED EMBODIMENTS OF THE INVENTION

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

Some embodiments of the present invention provide a system for determining reusable templates and parameters for evaluating quality of data that includes: a computing platform including at least one processing device; a data warehouse comprising information associated with data elements; a software module stored in the storage device, comprising executable instructions that when executed by the computer processing device causes the processing device to: (a) provide a plurality of element types, where each of the plurality of element types is defined by one or more features for identifying like data elements in the data warehouse; (b) provide a template for each of the plurality of element types, where each template is defined by one or more categories relating to one or more features of one of the plurality of element types; (c) use input from the template for each of the plurality of elements types to generate one or more parameter files for one or more data elements; (d) provide the one or more parameter files to one or more workflow processes for generating queries that are used for measuring and evaluating the one or more data elements; and (e) parameterize the generated queries, such that the generated queries can be reused in measuring and/or evaluating data elements.

In some embodiments of the system, the plurality of element types includes a statistical element type, a classical element type, and a binary element type.

In some embodiments of the system, each of the statistical element type, the classical element type, and the binary element type is defined by unique features such that data elements having like unique features that can be identified when compared to each of the statistical element type, the classical element type, and the binary element type.

In some embodiments of the system, the software module further comprises executable instructions that when executed by the at least one processing device causes the system to: receive information from a user for input into the template for each of the plurality of element types, the information comprising, at least, a name of a key data element, one or more rules for measuring a data quality of the key data element, and a data table in which information relating to the key data element is found.

In some embodiments of the system, the one or more workflow processes includes: (a) loading the input from the template for each of the plurality of element types into a staging table and filtering duplicate records from the input for load, (b) loading distinct global filters with unique identifiers from the input into a staging table for global filters, (c) loading data related to key business element, key data element, and column from the input into a staging table for parameters, and (d) loading rules from the input into a rules table.

In some embodiments of the system, the one or more parameter files are embedded with source queries required for the one or more data elements.

In one aspect of the invention, a method is provided for determining reusable templates and parameters for evaluating quality of data. The method includes using a computer processor to execute computer program code instructions stored in one or more non-transitory computer-readable mediums, wherein said computer program code instructions are structured to cause said computer processor to: (a) provide a plurality of element types, where each of the plurality of element types is defined by one or more features for identifying like data elements in the data warehouse; (b) provide a template for each of the plurality of element types, where each template is defined by one or more categories relating to one or more features of one of the plurality of element types; (c) use input from the template for each of the plurality of elements types to generate one or more parameter files for one or more data elements; (d) provide the one or more parameter files to one or more workflow processes for generating queries that are used for measuring and evaluating the one or more data elements; and (e) parameterize the generated queries, such that the generated queries can be reused in measuring and/or evaluating data elements.

In some embodiments of the method, the plurality of element types includes a statistical element type, a classical element type, and a binary element type.

In some embodiments of the method, each of the statistical element type, the classical element type, and the binary element type is defined by unique features such that data elements having like unique features can be identified when compared to each of the statistical element type, the classical element type, and the binary element type.

In some embodiments of the method, the software module further comprises executable instructions that when executed by the at least one processing device causes the system to: receive information from a user for input into the template for each of the plurality of element types, the information comprising, at least, a name of a key data element, one or more rules for measuring a data quality of the key data element, and a data table in which information relating to the key data element is found.

In some embodiments of the method, the one or more workflow processes includes: (a) loading the input from the template for each of the plurality of element types into a staging table and filtering duplicate records from the input for load, (b) loading distinct global filters with unique identifiers from the input into a staging table for global filters, (c) loading data related to key business element, key data element, and column from the input into a staging table for parameters, and (d) loading rules from the input into a rules table.

In some embodiments of the method, the one or more parameter files are embedded with source queries required for the one or more data elements.

In another aspect, a computer program product for determining reusable templates and parameters for evaluating quality of data is provided that includes a non-transitory computer-readable medium, wherein the non-transitory computer-readable medium comprises one or more computer-executable program code portions that, when executed by a computer, cause the computer to: (a) provide a plurality of element types, where each of the plurality of element types is defined by one or more features for identifying like data elements in the data warehouse; (b) provide a template for each of the plurality of element types, where each template is defined by one or more categories relating to one or more features of one of the plurality of element types; (c) use input from the template for each of the plurality of elements types to generate one or more parameter files for one or more data elements; (d) provide the one or more parameter files to one or more workflow processes for generating queries that are used for measuring and evaluating the one or more data elements; and (e) parameterize the generated queries, such that the generated queries can be reused in measuring and/or evaluating data elements.

In some embodiments of the computer program product, the plurality of element types includes a statistical element type, a classical element type, and a binary element type.

In some embodiments of the computer program product, each of the statistical element type, the classical element type, and the binary element type is defined by unique features such that data elements having like unique features can be identified when compared to each of the statistical element type, the classical element type, and the binary element type.

In some embodiments of the computer program product, the software module further comprises executable instructions that when executed by the at least one processing device causes the system to: receive information from a user for input into the template for each of the plurality of element types, the information comprising, at least, a name of a key data element, one or more rules for measuring a data quality of the key data element, and a data table in which information relating to the key data element is found.

In some embodiments of the computer program product, the one or more workflow processes includes: (a) loading the input from the template for each of the plurality of element types into a staging table and filtering duplicate records from the input for load, (b) loading distinct global filters with unique identifiers from the input into a staging table for global filters, (c) loading data related to key business element, key data element, and column from the input into a staging table for parameters, and (d) loading rules from the input into a rules table.

In some embodiments of the computer program product, the one or more parameter files are embedded with source queries required for the one or more data elements.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a general process flow 100 for determining reusable templates and parameters for evaluating the quality of data of data elements stored in a data warehouse, in accordance with some embodiments of the present invention.

FIG. 2 illustrates a data model 200 for describing features, concepts, and processes for measuring data quality of one or more key data elements, in accordance with some embodiments of the present invention.

FIG. 3 illustrates a process flow for loading data from templates into a database and filtering the data, in accordance with some embodiments of the invention.

FIG. 4 illustrates a process flow for extracting distinct global filters having a unique identifier, in accordance with some embodiments of the present invention.

FIG. 5 illustrates a process flow for extracting key data element information from a staging table, in accordance with some embodiments of the present invention.

FIG. 6 illustrates a process flow for loading rules into a staging table, in accordance with some embodiments of the present invention.

FIG. 7 illustrates a process flow for generating parameter files, in accordance with some embodiments of the present invention.

FIG. 8 is block diagram illustrating a system 800, in accordance with some embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

A “key business element,” as referred to herein, is a portion or element of information obtained in the course of conducting business. Thus, key business elements may be obtained during transactions involving a consumer and a business merchant or during transactions involving only business merchants or the like. For example, during a purchase transaction at a retail store a consumer may provide an item having an item number for purchase, a phone number, and a credit number to be used for payment. In such an example, the phone number, credit number, and/or the item number may be considered key business elements.

A “key data element,” as referred to herein, is how a key business element is referenced in a physical database.

Present embodiments of the invention provide systems, methods, apparatus, and computer program products for determining reusable templates and parameters for evaluating the quality of data. Currently, an entity that is attempting to measure the quality of data of various data elements in its datastores must individually identify each of the data elements that exist in the datastores and similarly, provide a unique rule for measuring the quality of each individual data element. The process of providing a unique rule for each individual data element can be cumbersome, slow, and expensive because of the coding necessary for implementing measuring the process for, possibly, thousands of data elements. As such, embodiments of the present invention allow a user to define three primary data element types useable for capturing all relevant data elements, which simplifies the data quality check process for hundreds or thousands of data elements. Templates for each data element type are then defined. The templates can then be used to input information for identifying a key data element that requires a data quality check, rules for performing the data quality check, and other relevant information for processing the data quality check, such as location(s) of the key data element. Several workflows/mappings may be implemented that process some of the information from the templates and generate parameter files for the key data element. The workflows may involve the extraction, transformation, and loading of the data from the templates. Lastly, queries generated during the workflows and various features of the workflow processes are parameterized so that the queries generated and the various features of the workflow processes can be re-used for any number of key data elements or sources of key data elements.

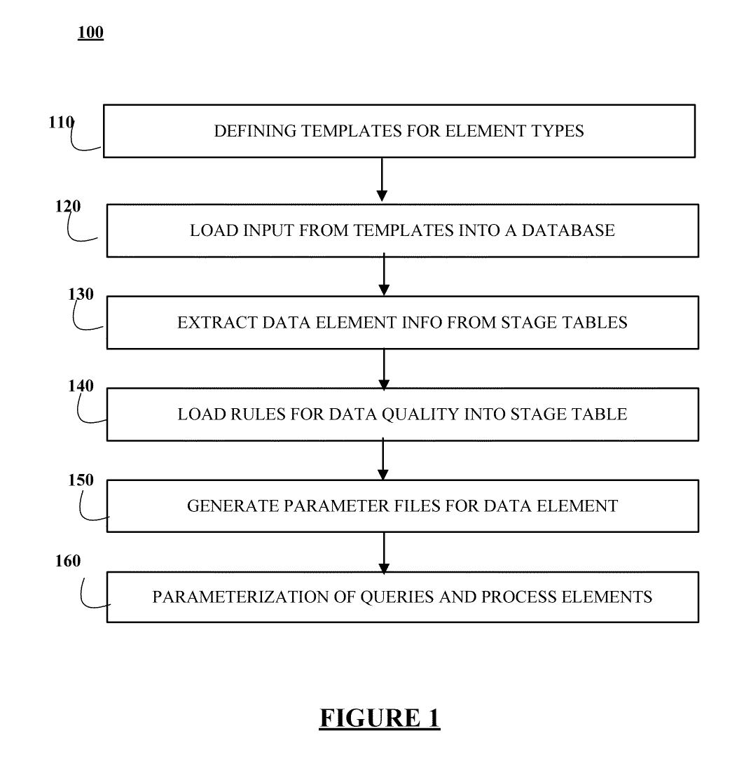

Referring now to FIG. 1, FIG. 1 illustrates a general process flow 100 for determining reusable templates and parameters for evaluating the quality of data of data elements stored in a data warehouse, in accordance with some embodiments of the present invention. As represented by block 110, a system executing process flow 100 receives input for defining templates for each of a plurality of element types. Each of the plurality of element types is defined such that data elements having like characteristics can be identified when compared to the element type. It will be understood that the term “like,” as used particularly in describing a relationship between an element type and a data element, generally refers to a data element being one or more of the following: the same form as an element type, similar to an element type, one or more features of an element type, one or more characteristics of an element type, that is identifiable by the element type, and/or is otherwise the same as an element type. In some exemplary embodiments, the templates are defined such that the plurality of element types includes a statistical element type, a binary element type, and a classical element type. In such an embodiment, each of the element types identifies one or more categories of data elements stored in a data warehouse. Thus, each individual data element of a plurality of data elements stored in a data warehouse is classified as being, at least, one of the three element types, i.e., statistical, binary, or a classical element type. As an example, a data warehouse may have stored therein 2000 unique data elements. In such an example, of those 2000 unique data elements, a first portion of the unique data elements may fall under the definition of a statistical element type such that 900 of the 2000 data elements are accounted for by the statistical element. Further with the example, a second and a third portion of the data elements within the data warehouse may fall respectively under the definition of a binary element type and a classical element type, such that another 600 and 500 data elements of the 2000 unique data elements in the data warehouse are accounted for by the binary element type and the classical element type, respectively. In this example, the total number of unique data elements fitting under one of the statistical, binary, or classical element types are different and do not have overlapping data elements. It will be understood that the previous example is just an illustration and should be limiting. In some instances, one or more elements may by definition fit under more than one of the statistical, binary, or classical element types.

Still regarding block 110, each template for the plurality of element types may be defined by a series of categories for which each of the templates is configured for receiving input related to the categories. As an example, a template for evaluating statistical data elements may be defined by categories including, but not limited to, a key business element name, the business group or system hosting information relating to key data elements, definition/name of a key data element as it exists in a physical database, a column name, a table name describing the database in which the key data element is stored, and a global filter for filtering information for multiple reports. As another example, a template for evaluating binary data elements may be defined by categories including, but not limited to, a key business element name, the business group or system hosting information relating to key data elements, definition/name of a key data element as it exists in a physical database, a column name, a table name describing the database in which the key data element is stored, a binary filter, and a global filter for filtering information for one or more reports.

The binary filter category of the binary template may be used to filter data elements by considering defined values of data elements unequal to zero as valid and zero values, as invalid. The opposite may also be used, such that values of data elements unequal to zero are invalid and values equal to zero are valid. It will be understood that the binary filter can be set up such that the defined values of the data elements are compared to numbers or values other than zero and one for determining the validity or invalidity of the defined values for the data elements.

As a last example, a template for evaluating classical data elements may be defined by categories including, but not limited to, a key business element name, the business group or system hosting information relating to key data elements, definition/name of a key data element as it exists in a physical database, a column name, a table name describing the database in which the key data element is stored, a global filter, a completeness rule, a format rule, a validity rule, and a reasonableness rule. The four additional rules including the completeness rule, the format rule, validity rule, and the reasonableness rule are included within the classical template for monitoring or measuring the quality of certain key data elements that are more complex than some key data elements falling under the definitions of a statistical template or binary template. The completeness rule, generally, relates to determining whether a field of data is complete or not. For example, if a key data element being evaluated is the name of a customer, then when being evaluated using a completeness rule both the first name and the last name of the customer must be present or exist in a customer name field in order to satisfy the completeness rule (e.g., Customer Name: First Last). The format rule, general, relates to ensuring that a key data element has a proper and/or useable format. As an example, if a key data element being evaluated is a social security number of a customer, then when being evaluated using a format rule the format of the numbers of the social security number should be first three numbers then second two numbers then last four numbers and some kind of element or space separating the sequence of numbers (e.g., ###-##-####). The validity rule, generally, relates to ensuring that a value of a key data element is within a domain of values. For example, if a key data element being evaluating is a gender of a customer, then in order to satisfy the validity rule, the gender of a customer must be either male or female (or any other identified gender) in order to satisfy the validity rule. The reasonableness rule, generally, relates to numerical values or amounts being within a reasonable range of values. For example, if a key data element being evaluated is an expected price range paid for a product X by customer should reasonable fall within a range of $20.00 and $30.00, and if a price paid for product X being evaluated by the reasonableness rule is $90.00 dollars then the price paid would not satisfy the reasonableness rule. It will be understood that the above examples relating to the completeness, format, validity, and reasonableness rules are just examples for demonstrating the utility of the rules and the rules should in no way be limited by the examples.

The specific rules for evaluating and measuring data elements of the three data element types may be provided under the global filter category or another category of each template. Generally, the rules for the binary template relate to a binary system of checking or measuring the quality of data, such that when the system measures the element and applies the binary rules to the data elements, the system will measure to determine whether a specific metric of the data element exists or does not exist. The rules for the statistical template, generally, relate to a statistical method for evaluating and/or measuring the quality of data, such that when the system measures the element and applies statistical rules to the data elements, the system may measure to determine whether a specific metric of the data element falls within specific thresholds or ranges. For example, using a set of statistical rules for measuring the quality of a data element, the system may apply a minimum and maximum value to each data element and measure to determine whether the data element falls within, above, or below the minimum/maximum threshold.

Now, in most embodiments, the template for each of the plurality of key data element types is different and as such, each template is configured to receive different types of information and/or rules relating to certain key data elements that may fall within the definition of the key data element type for which the template is created. The information that is input into each of the templates may be received from a user and/or agent of a business entity that maintains a system of databases having key data elements stored within the system of databases. For example, the user who is a data manager for a business group or division in an entity may want to ensure the quality of data managed by his business group and as such, will provide appropriate information into the template for performing the data quality check on key data elements in databases managed by the business group of the data manager.

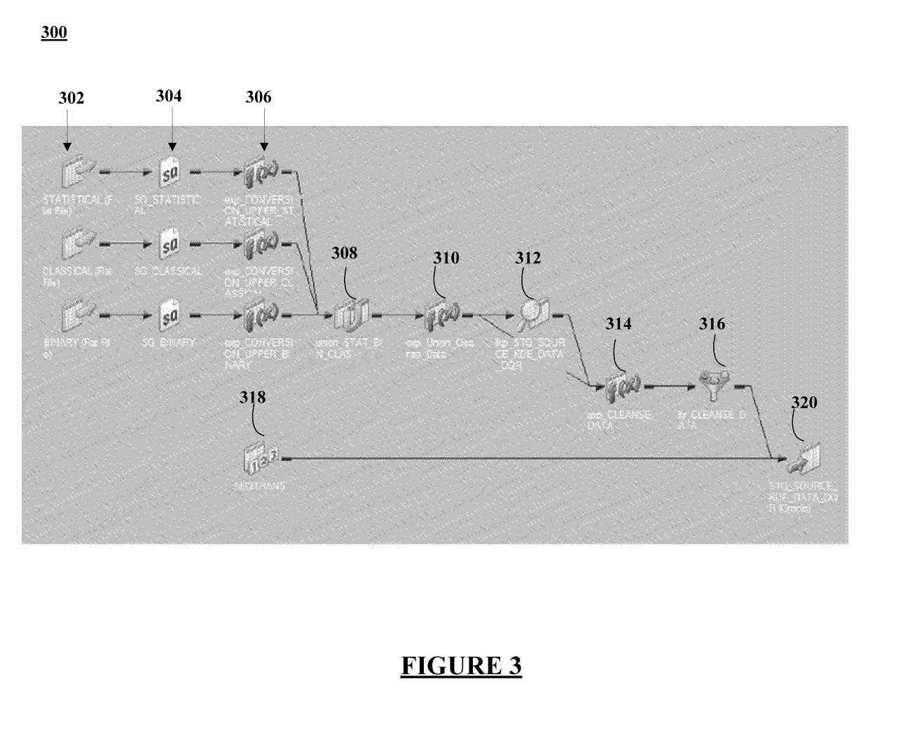

At block 120, once each template for the plurality of data element types is defined and input is received into each template, a system executing process flow 100 loads the input from each template into a database (e.g., operational database). The input, in some embodiments, comprises data relating to each of the plurality of categories defining each template for the plurality of data elements types. Once the input is received, the data from the input is categorized within each template by associating portions of the data to the one or more categories that the portions of data relate to. The input for the templates may be provided by and/or received from various agents and/or groups associated with an entity (e.g., a financial institution) that maintains key data elements. In most instances, business groups and/or divisions of the entity that generate key data elements in the normal course of business provide the input for the templates so that a data quality check may be performed on the generated key data elements. Subsequently, the data from each template for the plurality of data element types are combined into one excel spreadsheet and/or file for ease of use in a mapping and/or workflow process. Once combined, the system analyzes the rules data and/or other data within the combined file in order to eliminate duplicate rules records that exist in the combined file when compared to the rules that exist in the database. If and/or when found by the system, duplicated records in the combined file are filtered out of the combined file. The system then loads the only the unique rules and other data from the combined file into a staging table for key data element source information, which may be referred to herein as the “data source staging table.” Essentially, the information in the staging table is a cleaner and comprehensive table of information pulled from the templates. The staging table for key data element source information is loaded as the initial input file for several of the mappings and/or workflows described herein. The loading the data from the templates, filtering the duplicate records, and other processes involved in normalizing the data, as described in block 120, is further illustrated in the mapping shown in FIG. 3. FIG. 3 maps the logic and functions for loading input from a statistical template, classical, and binary template into a staging table and subsequently, filtering the data in the staging table to remove duplicate records. The mapping shown in FIG. 3 can be stored for ease of access and use at a later time.

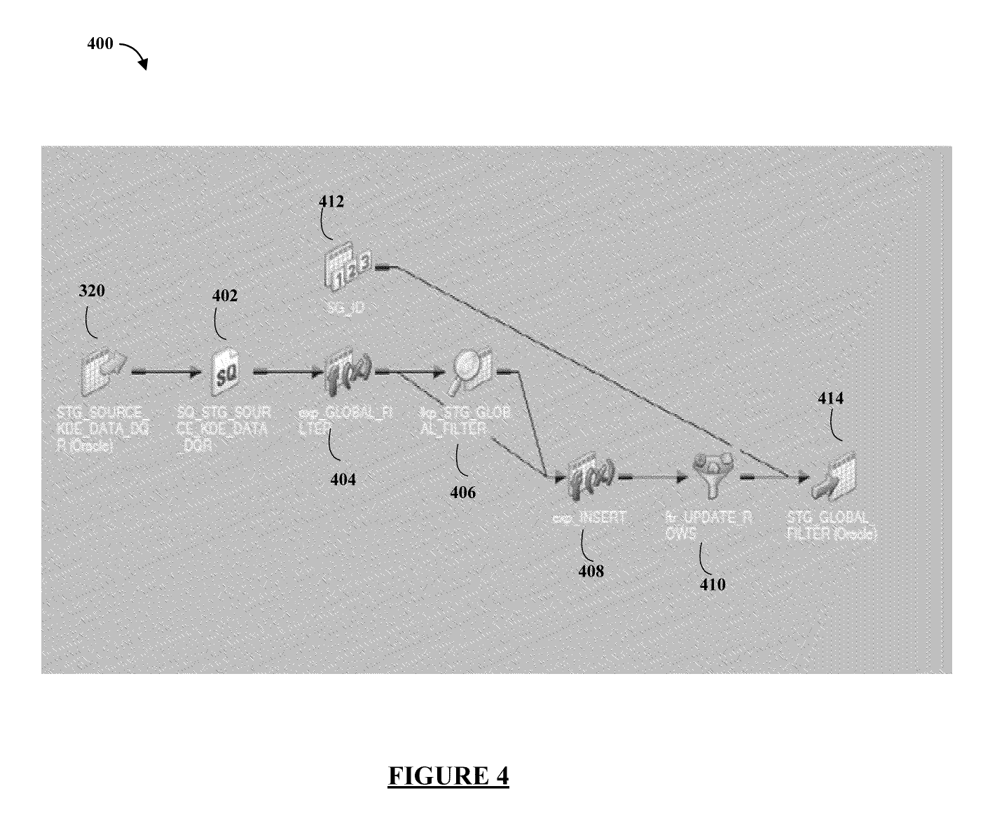

Continuing with block 120, the system then extracts only the global filters with a unique identifier from the data source staging table. The system then will load the global filters having a unique identifier into a new staging table configured for storing information only relating to the extracted global filters. The extracting of distinct global filters with unique identifiers is further illustrated in the mapping as shown in FIG. 4. FIG. 4 maps the logic and functions for extracting distinct global filters from a staging table and other processes involved in normalizing the data, in accordance with embodiments described herein. The mapping shown in FIG. 4 can be stored for ease of access and use at a later time.

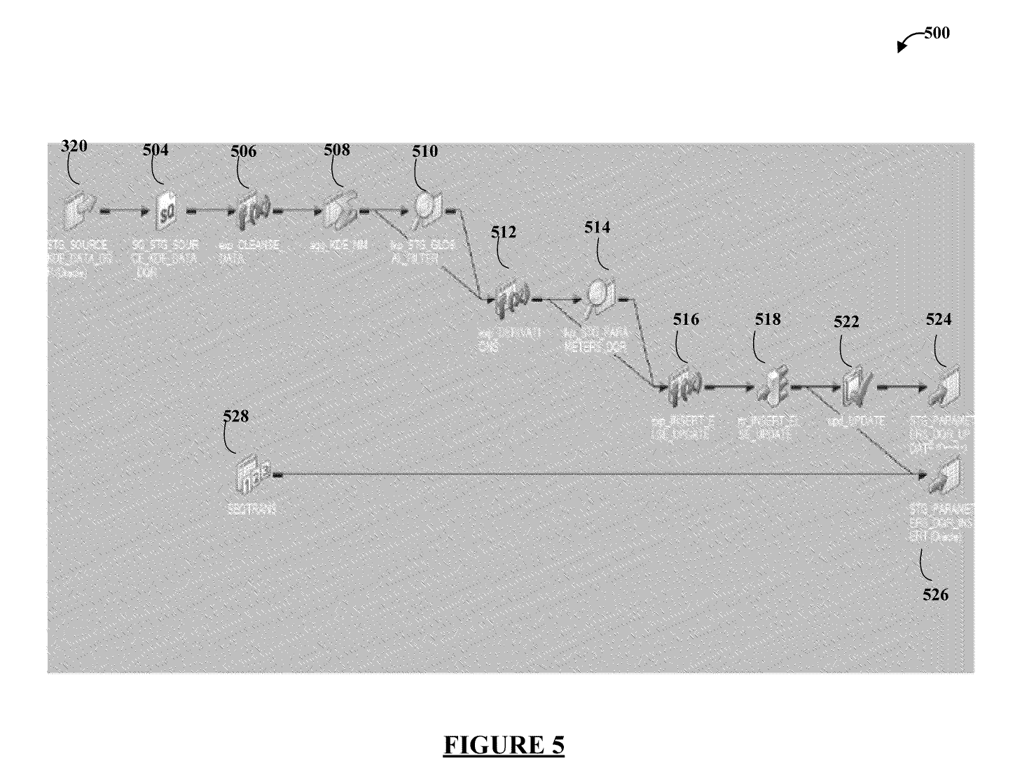

As represented by block 130, the system executing process flow 100 extracts data element information from the data source staging table. The data element information extracted from the staging table may include information categorized under or is related to key business element data category and key data element data category of each template for the plurality of element types. This data element information may undergo a series of processes performed by the system including transformation, data cleansing, and other processes involved in normalizing the data. Once the processes to the key business element information and key data element information are completed, the key business element information is stored in kbe staging table and the key data element information is stored in a kde staging table. Extracting data element information is further illustrated in the mapping shown in FIG. 5. FIG. 5 maps the logic and functions for extracting data element information. The mapping shown in FIG. 5 can be stored for ease of access and use at a later time.

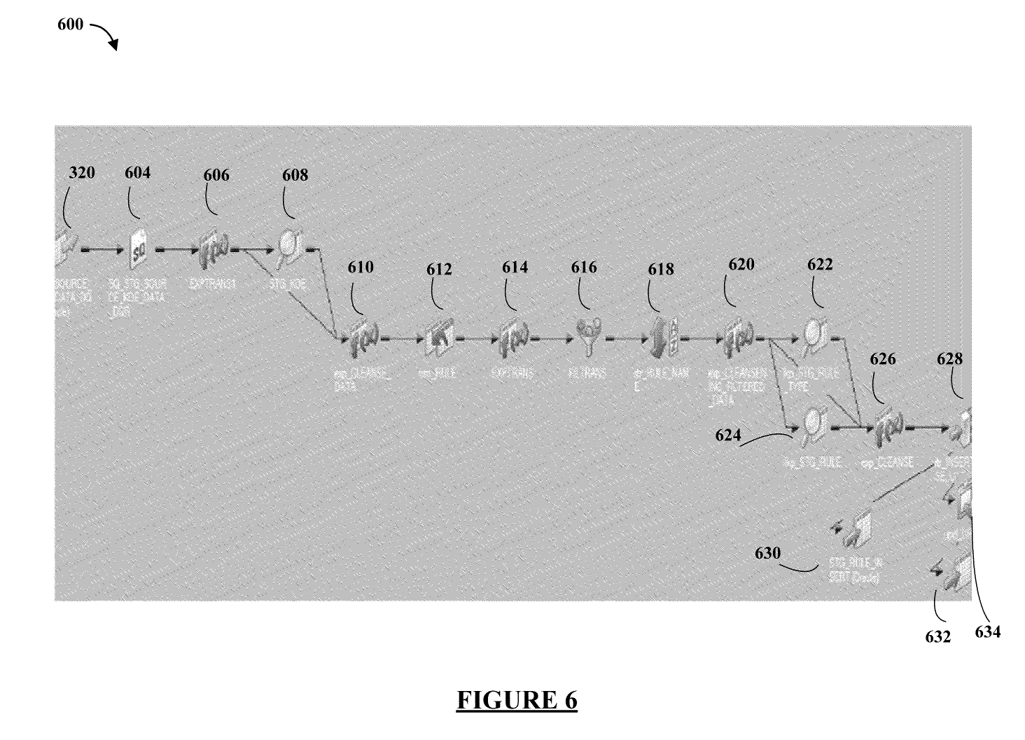

As represented by block 140, the system executing process flow 100 loads rules for measuring the quality of data of key data elements into one or more staging tables for rules. In some embodiments, the system may extract the rules from the data source staging table having the input from each template for the plurality of element types. The rules may undergo a series of processes performed by the system including transformation, data cleansing, and other processes involved in normalizing the data, as shown in FIG. 6. FIG. 6 illustrates a mapping of loading the rules. FIG. 6 maps the logic and functions used in loading the rules into the rules tables. The mapping shown in FIG. 6 can be stored for ease of access and use at a later time.

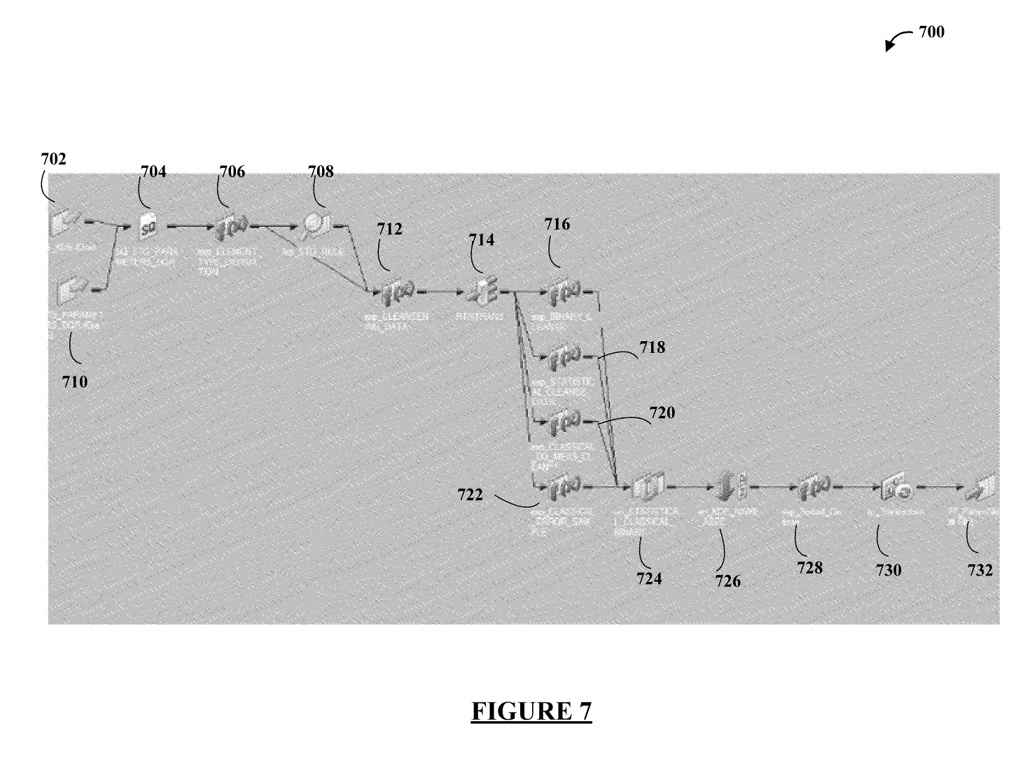

As represented by block 150, the system executing process flow 100 generates a parameter file for each rule and/or for each key data element. The parameter files for a key data element may generally include text or binary files for initializing a process that specifies a location of files for evaluating a key data element, memory allocation for processing a key data element, where to store files related to the key data element in a database or otherwise, and the like. In some embodiments, the system will generate parameter files that include, at least, one or more source queries, date constraints, database constraints, and database connections. The database connections, database constraints, date constraints, and source queries and/or the like may be obtained or referenced from one or more process mappings, such as those and/or including those shown in FIGS. 3-7. The parameters, in some embodiments, may also include hardcoded sequences. In some embodiments, during the generation process for the one or more parameter files, the system embeds within the one or more parameters files one or more source queries for generating data relating to the key data element so that the data can be copied and the copy moved to its target destination (e.g., a staging table or the like). During the generation process for the one or more parameter files, the data associated with the parameter files may undergo a series of processes performed by the system, including extraction, transformation, data cleansing, staging, and combination, as shown in FIG. 7. FIG. 7 illustrates a mapping of the parameter files generation process. The mapping shown in FIG. 7 can be stored for ease of access and used at a later time.

Still regarding block 150, once the parameter files for each key data element are generated, the system places each parameter file into a preconfigured mapping for triggering queries to the database. The preconfigured mappings may include hardcoded sequences that outline the entire process for performing a data quality check on a key data element associated with an inputted parameter file. Each of a statistical template, binary template, and a classical template may have a preconfigured mapping that are configured to receive a parameter file for measuring a key data element using statistical, binary, or classical rules, respectively. The preconfigured mappings may incorporate and/or include portions of the mappings and/or workflows illustrated in FIG. 3 through FIG. 7. Placing the parameter files into the preconfigured mappings generates queries, from the parameter files, related to instructions for retrieving information related to the key element data, measuring the key element data, obtaining metrics for the key data elements, storing the metrics into fact tables or fact aggregate tables, and/or otherwise performing various processes for performing a data quality check of the key element data. The system may then collect the queries generated from the mapping workflows so that the queries can be parameterized and reused. The parameterization process is more fully described in block 160.

At block 160, the system executing process flow 100 implements parameterization of one or more queries and process elements for evaluating a quality of data of a key data element. Parameterization includes defining the processes, script or code, variables, mappings, queries, and/or other parameters necessary for evaluating the data quality of a key data element. Thus, in some embodiments, parameterization of the mapping workflows and/or queries generated therefrom associated with the use of a statistical template, a binary template, or a classical template for evaluating the data quality of key element data is provided, such that each parameterization of the processes involving the templates can be re-used for any number of key data elements and/or sources. As an example, a system may define as parameters the script, code, queries, and processes associated with the mappings, as described in FIG. 3 through FIG. 7, for evaluating key data elements.

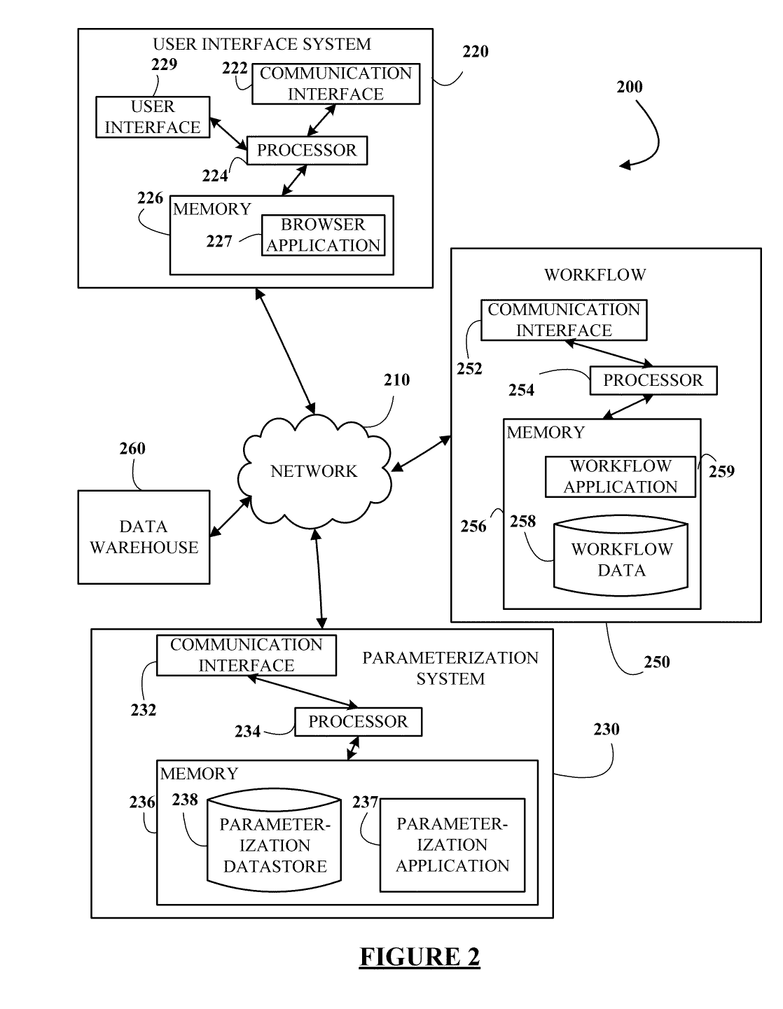

Referring now to FIG. 2, a system environment 200 for generating reusable templates and parameters for measuring key data elements is provided, in accordance with an embodiment of the present invention. System environment 200 includes a network 210, a user interface system 220, a parameterization system 230, a workflow system 250, and a data warehouse 260. As illustrated in FIG. 2, each of the portions of the system environment 200 is operatively connected to the network 210, which may include one or more separate networks. Additionally, the network 210 may include a direct connection, a local area network (LAN), a wide area network (WAN), and/or a Global Area network (GAN), such as the Internet. It should be understood that the network 210 may be secure and/or unsecure and may also include wireless and/or wireline technology.

Generally, using system environment 200, element type templates, such as a statistical template, binary template, and/or a classical template, may be provided via user interface system 220. User interface system 220, as described below, has one or more input features that allow a user, such as a data steward and/or business manager, to input data into the element type templates. Once the element type templates have data, workflow system 250 is configured to receive the templates, extract the data from the templates to initiate several mappings and workflows for generating staging tables and queries. Workflow system 250 then uses the generated staging tables to create parameter files for each key data element and associated rule for measuring the key data element. Parameterization system 230 receives the sequences from the workflows and/or mapping and the generated queries for the key data elements and initiates a parameterization process of those elements, so that these sequences, processes, and queries can be re-used when a new parameter file for evaluating a key data element is entered into the database.

More particularly and in accordance with some embodiments, the workflow system 250 is configured to perform each of the processes in the workflow diagrams (also known as mappings) shown in FIGS. 3-7, described below. As illustrated in FIG. 3, the workflow system 250 is configured to extract data from one or more input files 302 for loading into a database that is used for performing data quality checks on key data elements. In some embodiments, the one or more input files may be templates for each of the plurality of elements types (e.g., statistical type, classical type, binary type, and/or the like). As an example, the one or more input files may include a statistical template, a classical template, and a binary template in an excel spreadsheet format, where the information included in each template is provided by one or more users or data stewards (e.g., business group managers). The one or more source qualifiers 304 are extraction and transformation tools that extract data from the one or more input files 302 and render the data from the one or more input files 302 into a readable format for a workflow application 259 operating on workflow system 250. Now, transformation function 306 is another extraction, transformation, and loading (ETL) tool used by workflow system 250 for transforming data into new or different formats, as required by workflow system 250. In the mapping shown in FIG. 2, transformation function 306 is not being used by workflow system 250, but instead, is simply a placeholder, in this mapping for showing that if a transformation were necessary, the transformation could be performed by transformation function 306. At union table 308, workflow system 250 joins together the data from the one or more input files 302, such that all the data relating extracted from the templates can be referenced from one table and in a format readable by workflow application 259. Using a cleansing function 310 and lookup function 312, the workflow system analyzes union table 308 to determine whether there are rules for performing quality checks in union table 308 that already exist in another database accessible to workflow system 250. When workflow system 250 identifies one or more rules in union table 308 having a duplicate, workflow system 250 then uses another cleansing function 314 and cleansing funnel 316 to funnel the duplicate rules out from union table 308. Thus, only unique rules provided into the input files 302 are loaded into the database. Now, using rules sequencing 318, workflow system 250 provides a random and distinct sequence of numbers and/or other characters to each the rules remaining in the union table 308 and subsequently and/or contemporaneously loads the rules and associated identifying sequence of numbers into a staging table 320.

Now, at FIG. 4, workflow system 250 is configured to load the staging table 320 for normalizing global filters. For each key data element being measured by the workflow system 250, at least one rule for measuring the key data element and a global filter for guiding the application of the rule is provided. In this way, the global filter acts as a selection criteria and/or data constraint that has to be applied to a table of data for identifying which of a plurality of data elements relating to one key data element will be measured by the one or more applicable rules. As an example, a table may have seven years or more of the most recent years of data relating to a key data element. In this example, a global filter indicating that only the last five years of data relating to the key data element should be examined and/or measured by the applicable rules. In such an example, applying the global filter to the table constrains the application of any rules to only the time frame identified in the global filter. It will be understood that a global filter can be any type of data selection criteria and/or data constraint and should not be limited to a temporal constraint for identifying relevant data in a table of data.

In normalizing the global filters, the workflow system 250 is configured to identify the global filters in staging table 320 that are associated with each rule for data quality measuring and related key data element. In this way, when the workflow system 250 determines that a global filter is used multiple times with different rules and key data elements in the staging table 320, the workflow system 250 is configured to reduce the replication of the global filter by providing one global filter into a separate global filter staging table 414 that references a plurality of rules and related plurality of key data elements in staging table 320. As an example, staging table 320 may have one hundred key data elements, one hundred unique rules for measuring the one hundred key data elements, and one hundred global filters for each of the one hundred key data elements. In such an example, ten of key data elements may have a similar or same global filter; such a global filter may require the applicability of the rules to only the most recent five years of data associated with the key data elements. In such an example, the workflow system 250 aims to reduce the replication of the global filters by creating a new staging table that will hold only unique global filters and where each unique global filter is linked to one or more rules and/or key data elements in staging table 320.

Now going through the mapping shown in FIG. 4, the workflow system 250 is configured to load previously generated staging table 320 into the database. The workflow system 250 generates kde source qualifier 402 which transforms data from staging table 320 into a format that is readable and useable by workflow application 259. Workflow system 250 then uses a global filter transformation function 404 and global filter lookup 406 to analyze staging table 320 in order to identify any duplicate global filters. The workflow system 250 is further configured to use insert function 408 and filter update function 410 to filter the duplicate global filters and provide the unique global filters into global filter staging table 414. Using unique identification application 412, workflow system 250 is configured to provide each unique global filter in the global filter staging table 414 a unique identifier, such as a unique numerical sequence and/or a unique alphanumeric sequence, and/or the like.

Now, in reference to the mapping shown in FIG. 5, here, workflow system 250 is generally configured to analyze staging table 320 in order to differentiate the information therein into two different sets of information relating to key business elements and key data elements and then provide each of the information relating to the two elements into two separate staging tables. Workflow system 250 begins by loading staging table 320 into the database and generating kde source qualifier 504. Workflow system 250 then uses cleanse function 506 and kde aggregation function 508 to separate out from staging table 320 information associated with key data elements. Workflow system 250 also a global filter lookup 510 to identify and separate out global filters relating to key data elements. The derivations function 512 and staged parameters lookup function 514 are used by workflow system 250 to identify and/or find other parameters and information related to the key data elements that may also be separated out. Then, using insert/update transformation function 516 and insert/update 518, workflow system 250 is configured to either insert into the database any new rules provided by staging table 320 or otherwise update rules in the database with revisions based on the data provided in staging table 320. Workflow system 250 checks the updates to the rules using update function 522. Once the key data elements and key business elements have been separated from one another, workflow system 250 loads the information associated with the key data elements into kde staging table 524 and loads the information associated with key business elements into kbe staging table 526, where each of the key data elements and key business elements are assigned unique identifiers by workflow system 250 by using kde/kbe sequence function 528.

Referring now to FIG. 6, workflow system 250 at FIG. 6 is generally configured to evaluate all of the rules in staging table 320 in order to update the rules and/or reorganize the rules. As provided in the excel spreadsheets of the one or more input files 302, the rules are input into one row by a user. Workflow system 250 in the mappings of FIG. 6 reorganizes the rules for the classical template, as an example, such that the completeness, reasonableness, validity, and format rule are in separate rows in a rules staging table. So, as shown in FIG. 6, workflow system 250 loads staging table 320 and source qualifier 604. Workflow system 250 then uses rules filter 616 to filter out any rules that already exist in the databases and the rules sorter 618 to sort the rules and arrange the rules according to some predetermined and/or user provided criteria. Workflow system 250 performs various updates and actions to the rules using cleansing filtered data function 620, staged rule type lookup 622, staged rule lookup 624, cleanse function 626, insert/update function 628, update function 634, staged rule insert function 630, and insert update function 632. The mapping in FIG. 6 also includes generic transformation function 606, staged kde lookup function 608, data cleansing function 610, rule name file 612, and filter transformation function 614 for performing the steps and processes associated with FIG. 6.

At FIG. 7, workflow system 250 configured to generate queries for rules and input the queries generated into separate parameter files. As illustrated in the mapping of FIG. 7, workflow system 250 is configured to load several staging tables, including first stage table 702 and second stage table 710. In some embodiments, the several staging tables loaded by the workflow system 250 are any and all the staging tables that were loaded in the mappings of FIGS. 3-6. As shown in the mapping in FIG. 7, workflow system 250 is configured to combine data related to the binary template 716, statistical template 718, classical data quality measure file 720, and classical error file 722 into template union table 724. In some embodiments, workflow system 250 uses key data element sorter 726 and sorting function 728 to sort and/or rearrange the data in the template union table 724. Then workflow system 250 uses transaction function 730 to generate a parameter file for each query generated by workflow system 250. Workflow system 250 then inserts each query that was generated into a respective parameter file 732. FIG. 7 also includes staged parameters source qualifier 704, element type derivation function 706, staged rule lookup 708, data cleansing function 712, and transaction transformation function 714, which one or more these elements may be used to generate queries for input into parameter files 730.

In one embodiment, the user interface system 220 is configured to allow a user to communicate with other networks and/or portions of the system 200 and/or vice versa. For example, the user may use the user interface system 220 to communicate with the parameterization 230 to provide input for templates associated with a plurality of elements types to communicate with workflow system 250 in order to request that the workflow system 250 communicate with the data warehouse 260 to measure the quality of data of one or more key data elements provided to the system 200. It will be understood that the user interface system 220 may be configured to facilitate real-time or substantially real-time communication between the user and other portions of the system 200.

It will also be understood that the user interface system 220 may include, for example, a personal computer system, a portion of a computer network, an Internet web browser operated by a processing device, a telephone, a mobile phone, a personal digital assistant, a public kiosk, a fax machine, and/or some other type of communication device. In one embodiment, as illustrated, the user interface system 220 includes a communication interface 222, a processor 224, a memory 226 having a browser application 227 and/or other network communication application, and a user interface 229. The communication interface 222 is operatively connected to the processor 224, which is operatively connected to the user interface 229 and the memory 226 having the browser application 227.

Each communication interface described herein, including the communication interface 222, includes hardware, and, in some instances, software, that enables a portion of the system 200, such as the user interface system 220, to transport, send, receive, and/or otherwise communicate information to and/or from one or more other portions of the system 200. For example, the communication interface 222 of the user interface system 220 may include a modem, server, and/or other electronic device that operatively couples the user interface system 220 to another electronic device, such as the communication interface 232 of the parameterization system 230.

Each processor described herein, including the processor 224, includes circuitry required for implementing the audio, visual, and/or logic functions of that portion of the system 200 to which the processor belongs. For example, the processor 224 of the user interface system 220 may include a digital signal processor device, a microprocessor device, and/or various analog-to-digital converters, digital-to-analog converters, and/or other support circuits. Control and signal processing functions of the user interface system 220 may be allocated between these devices according to their respective capabilities. The processor 224 may include functionality to operate one or more software programs based on computer-executable program code thereof, which may be stored, for example, in the memory 226 of the user interface system 220.

Each memory device described herein, including the memory 226 for storing the browser application 227 and other data, may include any computer-readable medium. For example, the memory 226 of the user interface system 220 may include volatile memory, such as volatile random access memory (RAM) including a cache area for the temporary storage of data. The memory 226 may also include other non-volatile memory, which may be embedded and/or may be removable. The non-volatile memory can additionally or alternatively include an EEPROM, flash memory, or the like. The memory 226 can store any one or more pieces of information and/or data used by the user interface system 220 to implement the functions of the user interface system 220.

The browser application 227 may comprise any computer-readable instructions configured to allow the user interface system 220 to communicate with other devices over a network using, for example, one or more network and/or system communication protocols. For example, in one embodiment, the browser application 227 includes an Internet web browser used by the user interface system 220 for communicating with various portions of the system 200.

The user interface 229 generally includes one or more user output devices, such as a display and/or speaker, for presenting information to a user. The user interface 229 further includes one or more user input devices, such as one or more keys or dials, a touch pad, touch screen, mouse, microphone, camera, and/or the like, for receiving information from the user.

Also illustrated in FIG. 2 is a parameterization system 230, in accordance with one embodiment of the present invention. The parameterization system 230 may include, for example, a portion of a computer network, an engine, a platform, a server, a datastore system, a front end system, a back end system, a personal computer system, and/or some other type of computing device. In one embodiment, as illustrated, the parameterization system 230 includes a communication interface 232, a processor 234, and a memory 236 having a parameterization application 237 and a parameterization datastore 238. The communication interface 232 is operatively connected to the processor 234, which is operatively connected to the memory 236 having the parameterization application 237 and the parameterization datastore 238.

In one embodiment, the parameterization application 237 includes computer-executable program code for instructing the processor 234 to extract queries generated by the workflow system 250 for parameterization for re-use during a future session for measuring the quality of data a key data element or source of a key data element. The parameterization application 237 further includes computer-executable program code for instructing the processor 234 to evaluate individual processes of a process flow from workflow system 250, such as the methods and processes illustrated in FIGS. 1, 3, 4, 5, 6, and 7, in order to determine whether that individual element should also be parameterized for re-use. In this regard, in one embodiment, the parameterization application 237 includes computer-executable program code for instructing the processor 234 to determine one or more parameterized elements. Indeed, it will be understood that the parameterization application 237 may include computer-executable program code for instructing the processor 234 to perform any one or more of the events described herein that relate to determining templates and parameters for evaluating key data elements.

Further illustrated in FIG. 2 is the data warehouse 260, in accordance with some embodiments of the invention. In some embodiments, the data warehouse 260 is configured to store key element data and various other information related to key element data. For example, in one embodiment, the data warehouse 260 comprises key element data associated with two or more business groups in a financial institution. The data warehouse 260 may also be configured to save input data related to the templates, which may include rules for measuring key data elements, file locations, element types, and the. It will be understood that, in at least one embodiment, the data warehouse 260 provides a substantially real-time representation of the data and/or one or more rules contained therein, so that when the processor 234 accesses the data warehouse 260, the information stored therein is current or substantially current.

As illustrated in FIG. 2, the memory 236 also comprises a parameterization datastore 238. In some embodiments, the parameterization datastore 238 comprises one or more parameterized elements, such as the queries previously-described herein. For example, the parameterization datastore 238 may comprise information relating to the features of the queries generated by the workflows and features of one or more of the process elements of a workflow in which the queries are generated.

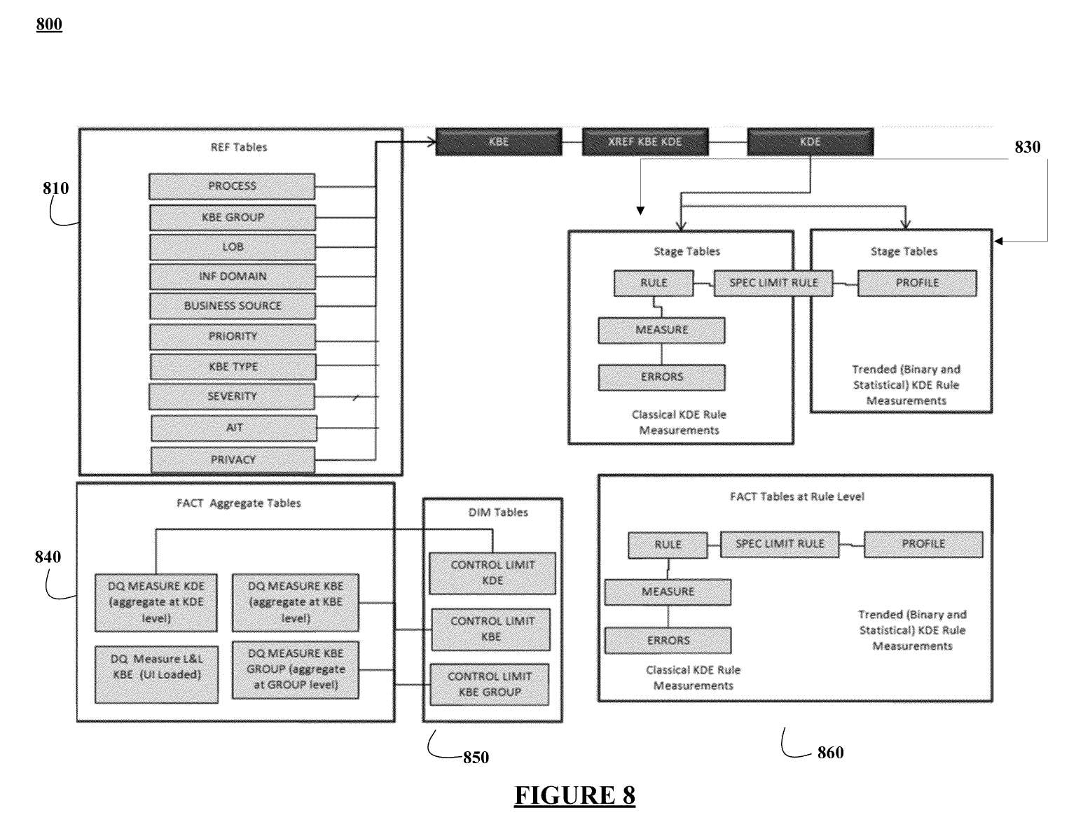

Referring now to FIG. 8, FIG. 8 illustrates a data model 800 for describing features, concepts, and processes for measuring data quality of one or more key data elements. The data model 800 includes reference tables 810, stage tables 830, fact aggregate tables 840, DIM tables 850, and fact tables at rule level 860.

In one embodiment, the reference tables 810 includes a process table, key business element (KBE) table, line of business (LOB) table, information (INF) domain table, business source table, priority table, key business element type table, severity table, AIT table, and privacy table. The reference tables 810 may be used by system 800 (described below) for referencing values and/or data for measuring data quality for any identified key data elements. Stage tables 830 of data model 800 are used as an intermediate storage area between sources of the data and the target end use or storage of the data in the stage tables. Key data element data or other data may be pulled from reference tables 810 and temporarily stored in stage tables 830 for later processing by system 800. The data in stage tables 830 can be quickly loaded from the operational database and thus freeing up the operational database as in a relatively short time. Any transformations that may occur using the data can then occur without interfering with the operation. Any data cleansing can also occur while the data is in the stage tables or by accessing the data in the stage tables and performing a cleansing thereto. The stage tables 830 may include a rules table for storing rules that are used to measure the quality of data of a key data element, a measure table for recording the measurement of each data element, an errors table for recording any errors in the measurement of data and otherwise, a specification limit rule table that includes upper and lower limits imposed on the data quality measuring process, and a profile that comprises characteristics and other information related to key data elements.

The fact aggregate tables 840 include tables for data quality measure of key data elements, key business elements, and a group of key business elements. A fact aggregate table is generally a database table that contains aggregated values for data elements. For example, a standard fact table related to customer purchase information may contain values and data in which the granularity is date of purchase, and item number for the purchase, and the customer identification (this value may be a number, e.g., customer number 23). Thus, the fact table can show all dates for which customer 23 has made a purchase, the item numbers for the products that were purchase on those dates, and the price paid on each date. In this instance, this fact table may have information associated with any number of customers, which maybe 23 customers or 1000 or more. The number of entries in the fact table is only limited by limitations imposed by the system or user for the amount of information that is desired to be in the table. The system or user can run queries against the fact table and it would return data. For example, a query may be sent to the table asking for the total number of sales for an item number (e.g., 12345) that customer #1 purchased in June of 2013 and the system would return a total sales number (e.g., $1,000). In most instances, the system would scan the fact table for 30 separate entries for each day of June, but using a fact aggregate table, similar to 840, that aggregates one or more values. For example, the fact table could be aggregated by month resulting in a fact aggregate table having monthly values for sales data. The fact aggregate table may now show total sales for customer #1 of item number 12345 for each month of the year. So that, when a query is sent to the table asking for total monthly sales, the system processes much faster because there is only one entry to find.

The dimension tables 850 are a set of companion tables to the fact aggregate tables 840. Dimension tables 850 contain various control limits relating to key data elements, key business elements, and key business element groups, as shown by elements 851, 852, and 853, respectively. The control limits of elements 851, 852, and 853 can provide minimum and maximum values for evaluating the quality of data within the fact aggregate tables 840. Information within the fact aggregate tables 840 may be compared against the control limits in dimension tables 850 in order to determine what information in the fact aggregate tables 840 falls within the range between the minimum and maximum values and to determine what information fall outside of the minimum and maximum values. The control limits may be any type of threshold for which the quality of data within the fact aggregate tables 840 may be measured against. Thus, in some instances, a control limit may only have one threshold value and not, necessarily, a minimum and maximum value. For example, data relating to purchase prices for a specific product may be described in a fact aggregate table, and in such an example, the system may check the quality of the purchase price data in the fact aggregate table by comparing the purchase price data to a control limit having a minimum and maximum value. The system or user may set value thresholds of the minimum and maximum of the control limit at $1.50 and $2.00, respectively, because it is understood by the user and/or the system that the specific product is usually not sold at prices outside of that range. In this example, the system may compare all prices paid for that specific product for a particular month. And, for any price that falls below the minimum value threshold or that exceeds the maximum value threshold, those prices are flagged for review and subsequent validation or investigation.

In addition, once the system has compared the control limits to a specified value from the fact aggregate tables 840, it may then determine ratios or percentages of values indicating the portion of values falling within the thresholds or ranges and the portion of values falling outside the threshold or ranges. The values falling within the ranges are considered to be passing and those that are not within the thresholds and/or ranges are considered not to be passing. The system may then compare the ratios or percentages of passing and failing values to various rules from fact table at rule level 860. In particular, the ratios and/or percentages of passing and failing values may be compared to specification limit rules, where the specification limit rules may be based on internal policies of the entity maintaining the data or external laws, policies, or regulations relating to minimum data quality requirements. For example, minimum data quality requirement imposed by regulation for a specific type of data may be that 90% of the specific type of data must be accurate or fall within a range of threshold values and that error in the specific type of data may not exceed 10%. In such an example, after measuring the quality of data for the specific type of data by comparing values from the fact aggregate tables to the control limits in the dimension tables, the system may determine that 89% of the data fall within the range of threshold values required by legislation and that 11% of the data contains errors. In such an instance, the system would determine that the specific type of data is non-compliant with regulatory requirements and subsequently, flag all values for the specific type of data that contained errors for specific validation and review by the system and/or a user.

As will be appreciated by one of ordinary skill in the art in view of this disclosure, the present invention may be embodied as an apparatus (including, for example, a system, device, computer program product, or any other apparatus), method (including, for example, a business process, computer-implemented process, or any other process), and/or any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product having a computer-readable storage medium having computer-executable program code embodied in the medium.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the present invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Embodiments of the present invention are described below with reference to flowchart illustrations and/or block diagrams of systems, methods, and computer program products according to embodiments of the invention. It will be understood that each block having the flowchart illustrations and/or block diagrams, and combinations of blocks in the flowchart illustrations and/or block diagrams, may be implemented by computer-executable program code. The computer-executable program code may be provided to a processor of a general purpose computer, special purpose computer, or other programmable data processing apparatus to produce a particular machine, such that the computer-executable program code portions, which execute via the processor of the computer or other programmable data processing apparatus, create mechanisms for implementing the functions/acts specified in the flowchart and/or block diagram block(s).

The computer-executable program code may also be stored in a computer-readable memory that can direct a computer or other programmable data processing apparatus to function in a particular manner, such that the instructions stored in the computer-readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for determining reusable templates and parameters for evaluating quality of data, the system comprising:
a computing platform including at least one processing device;
a data warehouse comprising information associated with data elements;
a software module stored in the storage, where the software module comprises executable instructions that when executed by the at least one processing device causes the system to:
provide a plurality of element types, where each of the plurality of element types is defined by one or more features for identifying like data elements in the data warehouse;
provide a template for each of the plurality of element types, where each template is defined by one or more categories relating to one or more features of one of the plurality of element types;
use data from the template for each of the plurality of elements types to generate one or more parameter files for one or more data elements;
provide the one or more parameter files to one or more workflow processes for generating queries that are used for measuring and evaluating the one or more data elements; and
parameterize the generated queries, such that the generated queries can be reused in measuring and/or evaluating data elements.

2. The system of claim 1, wherein the plurality of element types includes a statistical element type, a classical element type, and a binary element type.

3. The system of claim 2, wherein each of the statistical element type, the classical element type, and the binary element type is defined by unique features such that data elements having like unique features can be identified when compared to each of the statistical element type, the classical element type, and the binary element type.

4. The system of claim 1, the software module further comprises executable instructions that when executed by the at least one processing device causes the system to:
receive information from a user for input into the template for each of the plurality of element types, the information comprising, at least, a name of a key data element, one or more rules for measuring a data quality of the key data element, and a data table in which information relating to the key data element is found.

5. The system of claim 4, wherein the one or more workflow processes includes:
a) loading the input from the template for each of the plurality of element types into a staging table and filtering duplicate records from the input for load,
b) loading distinct global filters with unique identifiers from the input into a staging table for global filters,
c) loading data related to key business element, key data element, and column from the input into a staging table for parameters, and
d) loading rules from the input into a rules table.

6. The system of claim 1, wherein the one or more parameter files are embedded with source queries required for the one or more data elements.

7. A computer-implemented method for determining reusable templates and parameters for evaluating quality of data, the method comprising:
using a computer processor comprising computer program code instructions stored in a non-transitory computer readable medium, wherein said computer program code instructions are structured to cause said computer processor to:
provide a plurality of element types, where each of the plurality of element types is defined by one or more features for identifying like data elements;
provide a template for each of the plurality of element types, where each template is defined by one or more categories relating to one or more features of an element type;
use information from the template for each of the plurality of elements types to generate one or more parameter files for one or more data elements, where the one or more parameter riles is embedded with source queries required for the one or more data elements;
provide the one or more parameter files to one or more workflow processes for generating queries that are used for measuring and evaluating the one or more data elements; and
parameterize the generated queries, such that the generated queries can be reused in measuring and/or evaluating data elements.

8. The method of claim 7, wherein the plurality of element types includes a statistical element type, a classical element type, and a binary element type.

9. The method of claim 8, wherein each of the statistical element type, the classical element type, and the binary element type is defined by unique features such that data elements having like unique features can be identified when compared to each of the statistical element type, the classical element type, and the binary element type.

10. The method of claim 7, wherein the non-transitory computer-readable medium further comprises executable instructions that when executed by the at least one processing device causes the system to:
receive information from a user for input into the template for each of the plurality of element types, the information comprising, at least, a name of a key data element, one or more rules for measuring a data quality of the key data element, and a data table in which information relating to the key data element is found.

11. The method of claim 10, wherein the one or more workflow processes includes:
a) loading the input from the template for each of the plurality of element types into a staging table and filtering duplicate records from the input for load,
b) loading distinct global filters with unique identifiers from the input into a staging table for global filters,
c) loading data related to key business element, key data element, and column from the input into a staging table for parameters, and
d) loading rules from the input into a rules table.

12. The method of claim 7, wherein the one or more parameter files are embedded with source queries required for the one or more data elements.

13. A computer program product for determining reusable templates and parameters for evaluating quality of data, the computer program product comprising a non-transitory computer-readable storage medium having computer-readable program code stored thereon, such that when the computer-readable code is executed by a computer processor it causes the computer to:
provide a plurality of element types, where each of the plurality of element types is defined by one or more features for identifying like data elements;
provide a template for each of the plurality of element types, where each template is defined by one or more categories relating to one or more features of an element type;
use information from the template for each of the plurality of elements types to generate one or more parameter files for one or more data elements, where the one or more parameter riles is embedded with source queries required for the one or more data elements;
provide the one or more parameter files to one or more workflow processes for generating queries that are used for measuring and evaluating the one or more data elements; and
parameterize the generated queries, such that the generated queries can be reused in measuring and/or evaluating data elements.

14. The computer program product of claim 13, wherein the plurality of element types includes a statistical element type, a classical element type, and a binary element type.

15. The computer program product of claim 14, wherein each of the statistical element type, the classical element type, and the binary element type is defined by unique features such that data elements having like unique features can be identified when compared to each of the statistical element type, the classical element type, and the binary element type.

16. The computer program product of claim 13, the non-transitory computer-readable storage medium further comprises executable instructions that when executed by the at least one processing device causes the system to:
receive information from a user for input into the template for each of the plurality of element types, the information comprising, at least, a name of a key data element, one or more rules for measuring a data quality of the key data element, and a data table in which information relating to the key data element is found.

17. The computer program product of claim 16, wherein the one or more workflow processes includes:
a) loading the input from the template for each of the plurality of element types into a staging table and filtering duplicate records from the input for load,
b) loading distinct global filters with unique identifiers from the input into a staging table for global filters,
c) loading data related to key business element, key data element, and column from the input into a staging table for parameters, and
d) loading rules from the input into a rules table.

18. The computer program product of claim 13, wherein the one or more parameter files are embedded with source queries required for the one or more data elements.
